(19) United States
(12) Patent Application Publication
(10) Pub. No.: US 2009/0088135 A1
(43) Pub. Date: Apr. 2, 2009

(54) Access control for base stations

(76) Inventors: Sami Kekki, Helsinki (FI); Antti Toskala, Espoo (FI)

Correspondence Address: Hollingsworth & Funk, LLC, 8009 34th Avenue South, Suite 125, Minneapolis, MN, 54425, US

(21) Appl. No.: 12/154,417

(22) Filed: May 22, 2008

(30) Foreign Application Priority Data
Sep. 28, 2007 (FI) 20075681

(51) Int. Cl. H04Q 7/20; H04Q 7/22

(52) U.S. Cl. 455/411

(57) ABSTRACT

The present invention relates to a method for controlling access to a private base station. An identifier indicating an operation area previously accessed or detected by a communications device requesting communication with a private base station is received. The access to the private base station is controlled on the basis of the identifier.

### FIELD

The invention relates to access control for base stations, and in particular for private base stations.

### BACKGROUND

In order to provide a wireless broadband access and high data transfer rates at homes, base stations deployed at homes and communicating with user terminals have been available on the markets for some time. Wireless base stations or routers communicating with user terminals according to the IEEE 802.11x standard (Wireless Local Area Network or Wi-Fi) have been available for years but, recently, private base stations communicating according to cellular radio telecommunication standards have entered the markets. Private base stations are typically associated with uncoordinated deployment, i.e. the network infrastructure and coverage of a cellular telecommunication system is not based on the geographical deployment of the private base stations. A private base station may be called by many names, including Home Base Station, Home NodeB, femto eNodeB, or simply Home Access, and it has become a popular topic within operator and manufacturer communities.

A private base station is a consumer product for uncoordinated deployment, which is not under the control of an operator of a cellular network. The private base station may be located on a different frequency layer than public base stations. For example, one frequency layer of 5 MHz in W-CDMA (Wide-Band Code Division Multiple Access) may be used in a public cell and a separate frequency layer for the private deployment, the private base station also being potentially intended to serve as a public capacity enhancement layer.

It can be assumed that an end user buys an economic private base station and installs the private base station as a physical entity at his home. The private base station then provides coverage and service to user equipment registered by the owner of the private base station. The private base station may be connected via a DSL (Digital Subscriber Line) and via a core network of the operator towards the Internet. The core network of the operator typically comprises one or more network nodes providing the user equipment with an IP (Internet Protocol) connection. In more detail, data packets sent/received by the user equipment are transferred between the user equipment and a peer entity (for example an Internet server or other user equipment) through the one or more network nodes.

A requirement for private base stations is that the system supports efficient mechanisms to restrict access to a private base station unless user equipment has access rights to communicate with a specific private base station. Correspondingly, user equipment should not unnecessarily attempt to camp on a cell of a private base station if it does not have access rights. Furthermore, there is a need to ensure that a private base station is used in the intended operating area.

### BRIEF DESCRIPTION

An improved solution is now provided for private base station access control. The invention is defined in the independent claims. Some embodiments of the invention are set forth in the dependent claims.

According to an aspect, there is now provided a method comprising: receiving an identifier indicating an operation area previously accessed or detected by a communications device requesting communication with a private base station, and controlling access to the private base station on the basis of the identifier.

According to another aspect, there is now provided a method comprising: defining an identifier associated with a neighboring cell or the last visited cell, and transmitting the identifier for a private base station. The invention and various embodiments of the invention provide several advantages, which will become apparent from the detailed description below.

### LIST OF DRAWINGS

Embodiments of the present invention are described below, by way of example only, with reference to the accompanying drawings, in which

FIG. 1 shows a radio system;

FIG. 2A illustrates an example of the structure of a base station;

FIG. 2B illustrates an example of the structure of a user terminal; and

FIGS. 3, 4, 5, 6, and 7 are flowcharts illustrating embodiments.

### DESCRIPTION OF EMBODIMENTS

Although the specification may refer to “an”, “one”, or “some” embodiment(s) in several places this does not necessarily mean that each such reference is to the same embodiment(s), or that the feature only applies to a single embodiment. Single features of different embodiments may also be combined to provide other embodiments.

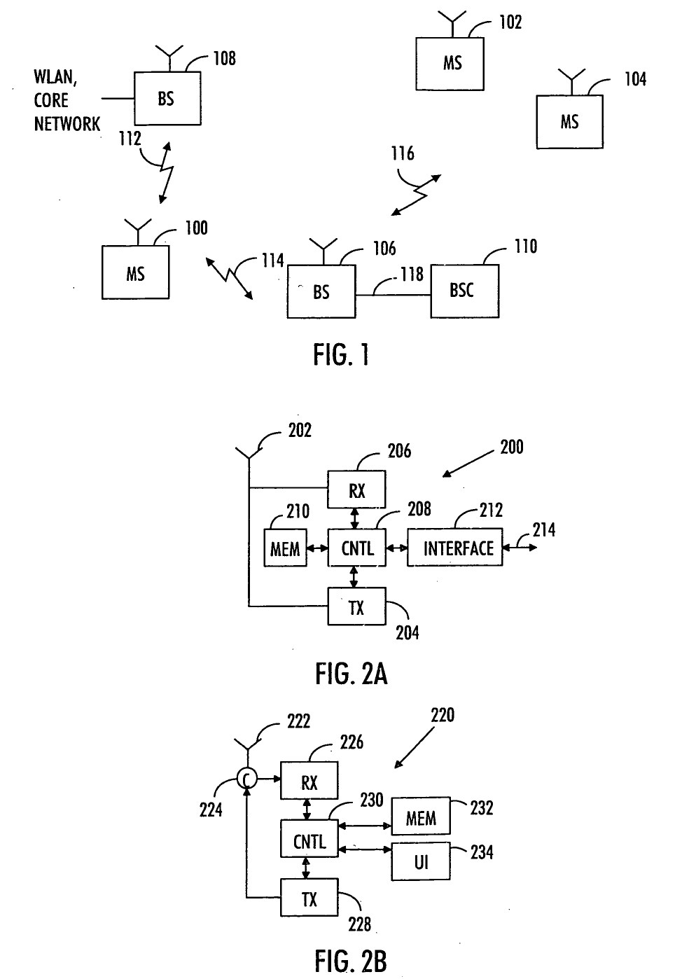

First, a radio system is described by means of FIG. 1. A digital radio system may comprise user equipment 100 to 104, at least one base station 106 to 108, and a base station controller 110, which can also be called a radio network controller. The user equipment 100 to 104, which may also be called user terminals or mobile stations, may communicate with the base stations 106 to 108 using signals 112 to 116. In this example, the base station 106 is a public base station serving all user terminals of the system. The base station 108 is a private base station intended to only serve the user terminal 100. The private base station may be located in the home of the user of the terminal 100, for example. The term “private base station” is used in the following; the private base station may refer to Home Base Station, Home NodeB, femto eNodeB, or Home Access, for instance.

The public base station 106 may have a connection to the base station controller 110 by a digital transmission link 118. The base station controller 110 provides a connection to other parts of the system and possibly the Internet (not shown). The private base station 108 may not necessarily be a part of the radio system, although in some embodiments the private base station may be connectable to a public radio system, such as a radio network controller or a macro (enhanced) node B of a 3GPP LTE (Long Term Evolution) access network. The private base station 108 is connected to a data transmission system for further connections to a core network, such as an IP backbone. For example, the private base station 108 may be connected to WLAN (Wireless Local Area Network), Ethernet, or DSL (Digital Subscriber Line) equipment further providing connectivity to the Internet. The signals 112 to 116 between the user terminals 100 to 104 and the base stations 106 to 108 carry digitized information, which is e.g. traffic data or control data.

It is to be noted that, for conciseness reasons, further elements of a typical wireless communications system are not described. For instance, the system may comprise one or more gateways providing connectivity for the private base station 108 to an operator's packet core network and/or the Internet. Further, a PLMN core network, such as an evolved 3GPP packet core network, may be provided with specifically configured functional elements for communications with the private base stations.

The radio system may be based on GERAN (GSM/EDGE RAN, where EDGE stands for Enhanced Data rates for Global Evolution and RAN stands for Radio Access Network), UTRAN (UMTS Terrestrial RAN) or LTE (Long Term Evolution) network elements, without being limited to them. The radio system may utilize HSDPA, HSUPA (High Speed Uplink Packet Access), WiFi (known as wireless fidelity), or WIMAX (Worldwide Interoperability for Microwave Access).

Each base station 106 to 108, both private and public, broadcasts a signal 112 to 116 such that a user terminal 100 to 104 can observe a potential base station and synchronize to the signal of the base station. The signal may comprise basic system information regarding the base station and the system the base station belongs to. The user terminal synchronizes to the base station signal, determines the basic system information and selects a base station with which to start a communication when switched on or for which to perform a handoff during normal operation. The user terminal then starts the communication with the selected base station.

As private base stations are typically located at homes, they are intended to serve the terminals of the users living at the location of the private base station. There is a need to restrict the use of the private base stations only in specific operation areas, such as a particular country in which the private base station is purchased. If there is no method to ensure what the country is where the home Node B is operated, an end user might take the base station with him when going to a foreign country, connect the base station, and end up calling by using a spectrum not allowed to be used by that operator and not necessarily even by that system in a foreign country. A private base station could be equipped with a user equipment receiver for detecting a broadcast channel (BCH) of the “home” network as the network might not be available in the location where the home Node B is being deployed. However, the additional cost of implementing the user equipment receiver in the home NodeB equipment is not attractive.

In an embodiment, information on the previously accessed or currently available operation area for the user terminal is used for controlling access to a private base station. In accordance with an aspect of the invention, the use of a private base station is allowed only in a predetermined operating area on the basis of this information. Hence, the use of private base stations can be limited to certain operation areas, such as countries. Separate user equipment receivers are not needed. When access control is arranged based on the information on the previously accessed operation area, it is possible to limit the access to a private base station even when macro coverage (by a public base station) is not available.

FIG. 2A illustrates an example of the simplified structure of a typical base station 200, such as the private base station 108. The base station comprises an antenna 202, a receiver 204, a transmitter 206, a controller 208, a memory 210 and an interface 212. In addition, the base station may comprise other modules as one skilled in the art is aware. Such modules may include an isolator to separate the receiver 204 and the transmitter 206, filters and other interfaces. In addition, the base station may comprise more than one transmitter and receiver pairs. Transmitters and receivers may be realized with a transceiver.

The base station 200 can transmit a signal such that a digital signal processed by the controller 208 is fed to the transmitter 206 for mixing the baseband signal up to a radio frequency signal which is guided to the antenna 202 to be transmitted as electromagnetic radiation. The signal to be transmitted may be received through the interface 212 or it may be obtained from the memory 210.

A radio frequency electromagnetic signal hitting the antenna 202, in turn, propagates to the receiver 204 which mixes the radio frequency signal down to a baseband signal, filters the analog signal and A/D-converts the signal to a digital form. To process the received signal, the receiver 204 forwards the baseband signal to the controller 208. The digital signal may be filtered and the data in the signal may be digitally processed. The controller 208 may save the data obtained from the pieces of analog and/or digital information of the received signal in the memory 210. The controller may forward the received data to the interface 212, which may forward 214 the data further to the core network or other parts of the system or to the Internet.

The user terminal 100 to 104 refers to a portable computing device. Such computing devices include wireless mobile communication devices operating with or without a subscriber identification module (SIM), including, but not limited to, the following types of devices: mobile phone, smartphone, personal digital assistant (PDA), handset. FIG. 2B illustrates an example of a simplified structure of a typical user terminal 220, such as a terminal 100 communicating with the private base station 108. The user terminal includes an antenna 222, an isolator 224, a receiver 226, a transmitter 228, a controller 230, a memory 232 and a user interface 234. The isolator 224 may be, for example, a circulator for separating the receiver 226 and the transmitter 228.

The user terminal 220 can transmit a signal such that a digital signal processed by the controller 230 is fed to the transmitter 228 for mixing the baseband signal up to a radio frequency signal, which is guided to the antenna 222 by the isolator 224 to be transmitted as electromagnetic radiation.

A radio frequency electromagnetic signal hitting the antenna 222, in turn, propagates through the isolator 224 to the receiver 226, which mixes the radio frequency signal down to a baseband signal, filters the analog signal and A/D-converts the signal to a digital form. To process the received signal, the receiver 226 forwards the baseband signal to the controller 230. The digital signal may be filtered and the data in the signal may be digitally processed. The controller 230 may save the data obtained from the pieces of analog and/or digital information of the received signal in the memory 232. The user interface 234 may comprise a microphone, a keyboard and a display and various other interfaces.

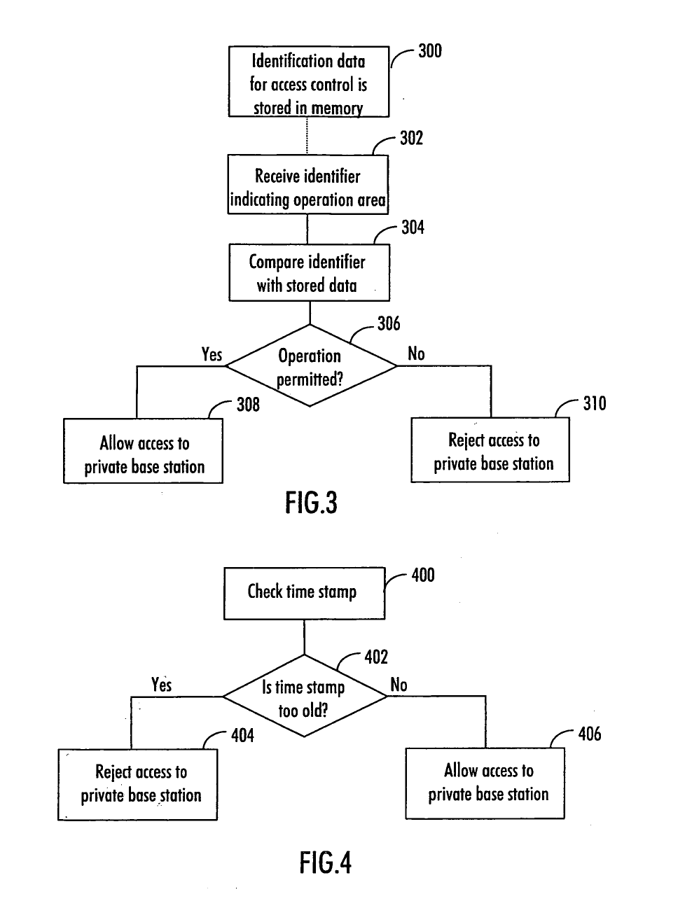

Let us study some further embodiments for arranging access control for private base stations. FIG. 3 is a flowchart illustrating an embodiment. In step 300, identification data of allowed and/or non-allowed operation areas is stored in a memory, such as the memory 210 of a private base station or a memory of another device controlling the access to a private base station. It is to be noted that the storage may be performed already before commissioning of the private base station, for instance by pre-configuration before selling the private base station to the end user. In one embodiment, the identification data may be stored, which may include replacement of identification data, later by a configuration management connection to the private base station.

In step 302, at least one identifier indicating an operation area visited or detected by a communications device requesting communication with the private base station is received.

In step 304, the received identifier is compared to at least part of the identification data in the memory to determine 306, if the operation of the private base station is allowed in the area indicated by the identifier.

If the operation is permitted, access to the private base station is allowed 308 and a connection may be established for the requesting communications device.

If the operation is not permitted, the private base station cannot be used in the area and access to the private base station is rejected 310.

In one embodiment, the identifier is in step 304, 306 compared to at least one pre-stored identifier indicating operation area(s) where the private base station is permitted to operate. Thus, if there is a match, access to the private base station is allowed 308. Alternatively, access to the private base station is rejected 310.

In another embodiment, identification data for non-allowed operation areas is stored in the memory, whereby access to the private base station is allowed, if there is no match between the stored identification data and the received identifier.

In one embodiment, the identifier indicates the current operation area of a mobile terminal, such as the user terminal 104. In another embodiment, the identifier indicates an operation area last visited by a mobile terminal.

FIG. 4 is a flowchart illustrating an embodiment. In step 400 a time stamp associated with the identifier indicating the last visited operation area is checked. In step 402 the procedure checks if the time stamp is sufficiently new enough. This may be performed on the basis of a comparison between the time elapsed from the creation of the time stamp and a predetermined maximum time stamp validity period, for instance. If the time stamp is too old, access to the private base station is rejected in step 404. In case the time stamp is sufficiently new enough, access to the private base station is allowed in step 406.

The steps of FIG. 4 may, in one embodiment, be applied before step 308 of FIG. 3. There may be two checking steps: First, the procedure checks if, based on the stored data, the operation is permitted in the area indicated by the identifier. Then, if the operation is permitted, the procedure checks if the time stamp associated with the identifier is sufficiently new enough. Only if these both conditions are satisfied, step 308 is entered. With reference to the base station of FIG. 2A, the controller 208 of the base station 200 may be configured to perform features illustrated in connection with FIGS. 3 and 4.

In another embodiment, these features are performed in some other network element controlling or authorizing the access for a private base station. Examples of such network elements are a radio network or access network controller, a core network element, such as a mobile switching center, a packet data transfer node, etc. Similarly to FIG. 2A, such a network element comprises a control unit, a memory and a network interface, but does not need to comprise any radio communications components 202, 204, and 206. There could be a controlling element even outside the mobile network for controlling the access to the private base station on the basis of the location area identifier.

Such a controlling network element may in step 308 or 310 transmit an authorization or rejection to the private base station. The private base station may be arranged to forward the location area identifier to a network element controlling the access to the private base station, wait for an authorization or rejection response message from the network element, and start or reject the access in accordance with the received response message.

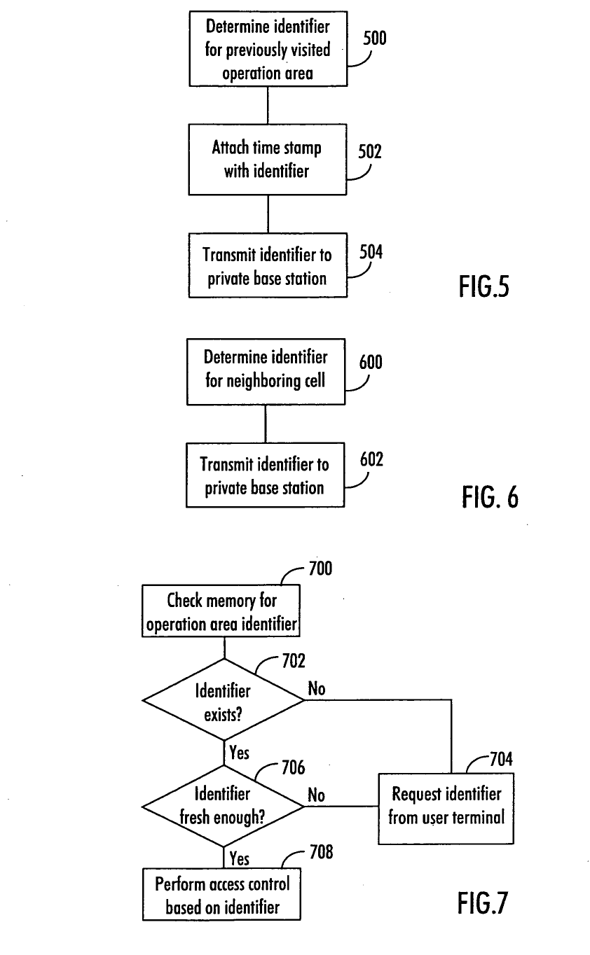

FIG. 5 is a flowchart illustrating an embodiment, which may be employed in an apparatus specifying the identifier for the private base station, such as the user terminal 100 for the private base station 108. In step 500 an identifier for the previously visited operation area is determined, which in one embodiment could be an identifier of the last measured cell. This information may be stored in the memory of the apparatus at connection set-up, for instance. In step 502 a time stamp is attached with the identifier. In step 504 the private base station is connected and the identifier associated with the time stamp is transmitted for access control purposes to the private base station or another entity controlling the access to the private base station. In step 504 the identifier associated with the time stamp may be retrieved from the memory, for instance.

FIG. 6 is a flowchart illustrating another embodiment, which may be employed in an apparatus specifying the identifier for the private base station. In step 600 one or more neighboring cell identifiers are determined. The identifier(s) may be determined on the basis of the cell information received from public and/or private base stations 106, 108. The identifier is transmitted in step 602 for the private base station or another entity controlling the access to the private base station for access control purposes.

In one embodiment, the private base station 108 or another entity controlling the access to the private base station is arranged to request the identifier for the previously visited and/or currently available operation area(s) from the user terminal. Hence, step 504 or 500 of FIG. 5, or step 602 of FIG. 6 may be entered in response to such a request. For instance, when detecting the request for the identifier, the user terminal searches for information for the neighboring cells in step 600 and reports the identifier(s) in step 602.

With reference to the steps illustrated in FIG. 3, after the identifier is received, the identifier is stored for later use. The steps illustrated in FIG. 3 for a received identifier may be applied for an identifier (locally) retrieved from a memory. This embodiment enables to reduce communications, since the information is transmitted only if necessary. For instance, the private base station may have recently received operation area information from another user terminal.

A reference is made to FIG. 7. In response to a need to perform access control for the private base station, a memory of the private base station or another entity performing the access control is checked 700, 702 for an operation area identifier.

If a location area identifier cannot be found, in step 704 a request for a location area identifier is transmitted to the user terminal. Then, the procedure may wait for the identifier from the user terminal and enter step 302 when the identifier is received.

If an identifier is found, the validity of the identifier is checked in step 706. For instance, the private base station may check a time stamp associated with the earlier received identifier or time of storage of the earlier received identifier. If the earlier received and stored operation area identifier is sufficiently new enough, in step 708 the private base station is arranged to omit the request transmission and perform the access control based on the stored identifier. For instance, the procedure may continue to step 304 of FIG. 3.

There may be further conditions and settings controlling if the private base station shall permit the access request and/or request for the identifier or not. In one embodiment, the private base station is always configured to request the identifier for the first access attempt after the private base station is switched on. Thus, a subsequent device accessing the private base station would not necessarily be anymore required to provide the identifier. The condition when further users are not required to provide the identifier could also be related to other conditions than a power on situation, for instance whether one of the private base stations is connected to the same transmission network domain as previously.

The steps, signaling messages and related functions described above in FIGS. 3 to 7 are not in an absolute chronological order, and some of the steps may be performed simultaneously or in an order differing from the given one. Other functions can also be executed between the steps or within the steps. Some of the steps or part of the steps can also be left out or replaced by an alternative step or part of the step.

In an embodiment, the operation area identifier used for access control purposes for the private base station is a country code of a previously visited or detected network. In another embodiment, the identifier is a network identifier of a previously visited or detected network. In a still another embodiment, the identifier is a public land mobile network identifier. In a still another embodiment, the identifier is a cell identifier. However, it is to be noted that apparatuses may be adapted to use identifiers other than those mentioned above. For instance, the identifier could be an identifier specifically provided from an overlaying network to the user terminal to be used for permitting private base station operation in this area. The mobile terminal may be arranged to obtain the identifier from a cellular network and transmit the identifier to enable the use of the private base station in a particular country or in a limited area. It is also to be noted that more than one identifier may be applied in the embodiments above.

In the following, different embodiments will be described using, as an example of a system architecture whereto the embodiments may be applied, an architecture based on long-term evolution (LTE) of the 3GPP system, without restricting the embodiment to such an architecture, however.

In current 3GPP LTE draft standards, Home Base Stations, Home (e)NodeB, Femto access point, or simply Home Access is used to refer to private base stations. Such 3GPP home NodeB may be configured to provide at least some of the features illustrated above for the private base station 102.

Let us study other examples of embodiments applied to a 3GPP type of system. In a 3GPP type of system, each base station transmits a Broadcast Channel (BCH), which is used for broadcasting information about the cell and the system. The BCH may comprise a Broadcast Control Channel (BCCH), which may be used to transmit basic system information.

In an embodiment, the private base station is configured to transmit an indication of a request for the operation area identifier on a broadcast control channel. In this manner, user terminals may detect the need to determine the currently visited or previously visited operation area and send it to the requesting private base station.

In one embodiment, the operation area identifier is transmitted from the 3GPP UE to the 3GPP private base station, or home eNodeB, in an access procedure message.

In one embodiment, the identifier is transmitted as part of the 3GPP system random access procedure. In a further embodiment, the user terminal is arranged to transmit and the private base station is arranged to receive the identifier in a random access channel message.

However, the above embodiments are only some examples of applicable transport procedures, and the transfer of the request and the identifier is not limited to any specific transmission format.

The processing unit of a base station, a control element controlling the access to a private base station and a user terminal may be implemented as an electronic digital computer, which may comprise a working memory (RAM), a processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

Embodiments of the invention, such as the ones illustrated above, may be implemented as a computer program comprising instructions configuring the processing unit for executing a computer process. The computer program may be embodied on a distribution medium.

The computer program may be in source code form, object code form, or in some intermediate form, and it may be stored in some sort of carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The processing units of a base station, a control element controlling the access to a private base station, and a user terminal may also be implemented as one or more integrated circuits, such as application-specific integrated circuits ASIC. Other hardware embodiments are also feasible, such as a circuit built of separate logic components. A hybrid of these different implementations is also feasible.

It will be obvious to a person skilled in the art that, as technology advances, the inventive concept can be implemented in various ways. The invention and its embodiments are not limited to the examples described above but may vary within the scope of the claims.

1. A method comprising:
receiving an identifier indicating an operation area previously accessed or detected by a communications device requesting communication with a private base station,
controlling access to the private base station on the basis of the identifier.

2. The method according to claim 1, wherein the identifier is compared to at least one predetermined identifier indicating operation area(s) where the private base station is permitted to operate,
access to the private base station is allowed in response to the identifier matching the at least one predetermined identifier, or
access to the private base station is rejected.

3. The method according to claim 1, the step of controlling access to the private base station further comprising:
checking a time stamp associated with the identifier,
controlling access to the private base station on the basis of the time stamp.

4. The method according to claim 1, wherein the identifier of the previously visited operation area is one of the following: country code, network identifier of a previously visited or detected network, public land mobile network identifier, cell identifier.

5. The method according to claim 1, wherein the identifier is sent from user equipment to the private base station in an access procedure message for establishing the access to the private base station.

6. An apparatus comprising:
an interface to transmit and receive data packets as communication signals; and
a processing unit, the processing unit being configured to receive an identifier indicating an operation area previously accessed or detected by a communications device requesting communication with a private base station, and to control access to the private base station on the basis of the identifier.

7. The apparatus of claim 6, wherein the apparatus is configured to compare the identifier to at least one predetermined identifier indicating one or more operation areas where the private base station is permitted to operate,
the apparatus is configured to allow access to the private base station in response to the identifier matching the at least one predetermined identifier, or
the apparatus is configured to reject access to the private base station.

8. The apparatus of claim 6, wherein the apparatus is configured to check a time stamp associated with the identifier, and
the apparatus is configured to control access to the private base station on the basis of the freshness of the time stamp.

9. The apparatus of claim 6, wherein the identifier of the previously visited operation area is one of the following: country code, network identifier of a previously visited or detected network, public land mobile network identifier, cell identifier.

10. The apparatus of claim 6, wherein the apparatus is configured to receive the identifier from user equipment in an access procedure message for establishing the access to the private base station.

11. The apparatus of claim 10, wherein the access procedure message is a random access channel message.

12. The apparatus of claim 6, wherein the apparatus is configured to transmit a request to the user equipment for transmitting the identifier in response to there being no earlier received identifier for the user equipment or a time stamp associated with an earlier stored identifier exceeding a predetermined maximum validity period, and
the apparatus is configured to perform the access control based on the identifier received in response to the request.

13. The apparatus of claim 6, wherein the apparatus is the private base station of a 3GPP system.

14. The apparatus of claim 6, wherein the apparatus is a control element for controlling the private base station, and
the apparatus is configured to transmit an authorization or rejection message to the private base station on the basis of the checking of the identifier.

15. A computer readable storage medium comprising program instructions for controlling a communications apparatus to
receive an identifier indicating an operation area previously accessed or detected by a communications device requesting communication with a private base station, and
control access to the private base station on the basis of the identifier.

16. An apparatus comprising:
means for transmitting and receiving data packets as communication signals being adapted to receive an identifier indicating an operation area previously accessed or detected by a communications device requesting communication with a private base station, and
means for controlling access to the private base station on the basis of the identifier.

17. An apparatus comprising:
an interface to transmit and receive data packets as communication signals over a radio interface; and
a processing unit configured to receive from a private base station or a control element controlling access to a private base station a request for an operation area identifier, to define, in response to the request, an identifier indicating an operation area previously accessed or detected by the apparatus, and to transmit a response including the identifier to control access to the private base station on the basis of the identifier.

18. An apparatus according to claim 17, wherein the apparatus is configured to transmit the identifier to the private base station in an access procedure message for establishing the access to the private base station.

19. An apparatus according to claim 17, wherein the apparatus is configured to obtain the identifier from a cellular network and transmit the identifier to enable the use of the private base station in a particular country or in a limited area.

20. A method comprising:
defining an identifier associated with a neighboring cell or the last visited cell, and
transmitting the identifier for a private base station.

21. The method according to claim 20, wherein a request from the private base station is sent to at least one terminal device for transmitting the identifier, and
the identifier is defined by the at least one terminal device in response to the request.

22. The method according to claim 21, wherein the request is sent by a broadcast control channel message to request the terminal device to report information on neighboring cells.

23. The method according to claim 20, the step of defining the identifier comprising:
searching for information on at least one neighboring cell, or
retrieving the identifier from the memory in response to failing to receive any macro cell information.

24. An apparatus comprising an interface to transmit and receive data packets as communication signals over a radio interface; and
a processing unit configured to define an identifier associated with a neighboring cell or the last visited cell and to transmit the identifier for a private base station to control the access to the private base station on the basis of the identifier.

25. The apparatus according to claim 24, wherein the apparatus is configured to receive a request for transmitting the identifier from the private base station, and
the apparatus is configured to define the identifier in response to the request.

26. The apparatus according to claim 24, wherein the apparatus is configured to receive the request by a broadcast control channel message to request the terminal device to report information on neighboring cells.

27. The apparatus according to claim 24, wherein the apparatus is configured to search for information on at least one neighboring cell, or
the apparatus is configured to retrieve the identifier from the memory of the apparatus in response to failing to receive any macro cell information.

28. The apparatus according to claim 24, wherein the apparatus is configured to associate a time stamp with the identifier.

29. The apparatus of claim 7, wherein the apparatus is configured to check a time stamp associated with the identifier, and
the apparatus is configured to control access to the private base station on the basis of the freshness of the time stamp.

30. An apparatus according to claim 18, wherein the apparatus is configured to obtain the identifier from a cellular network and transmit the identifier to enable the use of the private base station in a particular country or in a limited area.

31. The apparatus according to claim 25, wherein the apparatus is configured to receive the request by a broadcast control channel message to request the terminal device to report information on neighboring cells.
